(19) United States
(12) Patent Application Publication
(10) Pub. No.: US 2024/0085528 A1
(43) Pub. Date: Mar. 14, 2024

(54) OPTICAL DEVICE FOR NEAR AND DISTANCE IMAGING, AND SYSTEMS HAVING AN OPTICAL DEVICE

(71) Applicant: DEUTSCHES ZENTRUM FÜR LUFT- UND RAUMFAHRT E.V., 53227 Bonn (DE)

(72) Inventors: Raoul-Amadeus LORBEER, Magstadt (DE); Oliver KLIEBISCH, Herrenberg (DE); Peter MAHNKE, Stuttgart (DE); Nico MILLER, Stuttgart (DE)

(73) Assignee: DEUTSCHES ZENTRUM FÜR LUFT- UND RAUMFAHRT E.V., 53227 Bonn (DE)

(21) Appl. No.: 18/272,395

(22) PCT Filed: Dec. 21, 2021
(86) PCT No.: PCT/EP2021/087070

§ 371 Date: Jul. 14, 2023

(30) Foreign Application Priority Data
Jan. 15, 2021 (DE) 10 2021 100 788.7

(51) Int. Cl. G01S 7/481; G01S 17/34; G01S 17/50; G01S 17/95

(52) U.S. Cl. CPC G01S 7/4811; G01S 7/4818; G01S 17/34; G01S 17/50; G01S 17/95

(57) ABSTRACT

An optical device and systems for near and distance imaging includes an optical unit with a first optical lens and a second optical lens, the first optical lens and second optical lens being arranged along an optical axis, and a transceiver unit with a transceiver element, a light passage surface of the transceiver element being arranged in or intersecting a plane or curved surface. A first distance between the surface and the first optical lens is provided along the optical axis and set in such a way that, during intended normal operation, the transceiver element of the transceiver unit is imaged onto a distant imaging surface by the optical unit.

### BACKGROUND AND SUMMARY

The invention relates to an optical device for near and distance imaging, a system having an optical device for laser Doppler anemometry, a system for LIDAR measurements and a system for combined laser Doppler anemometry and LIDAR measurements, in particular frequency-modulated continuous wave LIDAR measurements.

Lidar systems are often used in vehicles. US 2015/146189 A1 discloses an optical device for a LIDAR system for a vehicle with a transceiver unit and an optical lens, which focuses the transmitted and received light for different image distances at close range.

An optical device with transceiver units is known from DE 10 2018 209394A1, in which all transmitters are respectively arranged in one plane and all receivers are respectively arranged in another plane.

An optical device for a LIDAR system for a vehicle is known from U.S. Pat. No. 8,836,922B1, with a plurality of transceiver units which are arranged at different distances from a lens and which are imaged in a common imaging plane.

In multi-channel laser Doppler anemometry (LDA) systems, it is common to use a separate optical system for each LDA channel Wind speed and wind direction, for example, can be determined by spanning a small angle in the range of 10° to 30° between the individual optical systems.

Multi-channel LDA systems are used commercially at wind farms and airports. The technology is also a common diagnostic method in wind tunnels and combustion technology test benches. There are also scientific studies on use on/in aircraft.

Frequency-modulated continuous wave LIDAR systems (FMCW-LIDAR=Frequency Modulated Continuous Wave Light Detection And Ranging) use lasers with similar optical systems as are usual with LDA.

In a reference beam LDA system, a spectrally very narrow-band laser beam is divided into a reference beam and a measurement beam. The measurement beam is focused into the air in order to scatter it on particles (aerosols). The frequency of the backscattered light is Doppler shifted by the intrinsic motion of the aerosols. The backscattered light is optically collected and made to interfere with the reference laser beam. This produces a beat signal proportional to velocity as intensity modulation. The aerosol movement and thus also the wind speed can also be measured in this way.

In an FMCW LIDAR system, the laser source is additionally subject to triangular frequency modulation over time. In particular, the beam is again divided into a measurement beam and a reference beam. The measurement beam is typically collimated. The photons scattered on a surface are captured again and superimposed with the reference beam. The movement of the object is reflected in a different sign of the Doppler frequency shift for both ramps of the triangular modulation. This allows the frequency component, from which the distance of the object can be determined, to be separated from the component that expresses the relative movement, namely the speed of the object.

The two measurement methods LDA and FMCW LIDAR are similar and complement each other in terms of their informative value.

It is desirable to create a compact optical device for near and distance imaging.

It is also desirable to provide a system for laser Doppler anemometry with a compact optical device.

It is also desirable to provide a system for frequency modulated continuous wave LIDAR with a compact optical device.

It is also desirable to provide a system for combined laser Doppler anemometry and frequency modulated continuous wave LIDAR measurements with a compact optical device.

According to an aspect of the invention, an optical device for near and distance imaging is proposed, comprising an optical unit with at least one first optical lens and at least one second optical lens, the at least one first optical lens and at least one second optical lens being arranged along an optical axis. The optical device also includes a transceiver unit with at least one, in particular an essentially punctiform, transceiver element for emitting and receiving light beams through the optical unit, a light passage surface of the at least one transceiver element being arranged in or intersecting at least one plane or curved surface.

A first distance between the at least one surface and the at least one first optical lens is set along the optical axis such that in normal operation as intended, the at least one transceiver element of the transceiver unit is imaged by the optical unit onto a distant imaging surface.

Alternatively, a second distance between the at least one surface of the at least one transceiver element and the at least one first optical lens is set along the optical axis so that in normal operation as intended, the light beam emitted by the at least one transceiver element is formed to be collimated at least after the second lens.

Alternatively, a first distance between the at least one surface and the at least one first optical lens is set along the optical axis so that in normal intended operation, the at least one transceiver element of the transceiver unit is imaged by the optical unit onto a distant imaging surface and a second distance between the at least one surface of at least one additional transceiver element of the transceiver elements and the at least one first optical lens, which is different from the first distance, is set so that in normal intended operation, the light beam emitted by the at least one additional transceiver element is formed to be collimated at least after the second lens.

A plurality of transceiver elements can be provided with the first distance. A plurality of transceiver elements can be provided with the second distance. The system advantageously offers an almost diffraction-limited imaging quality, in particular for “tilted” beams. This is particularly useful with coherent methods such as LDA or FMCW in order to maximize the signal strength, as these work confocally.

The optical device according to the invention consists of as few components as possible, namely at least two optical lenses, which enable refocusing of light in a conical imaging region with an essentially diffraction-limited imaging quality. The two optical lenses can preferably be designed as aspherical lenses. In this way, a plurality of LDA optical units can advantageously be combined in an optical system, as a result of which the number of LDA channels can be increased at low cost.

This is particularly relevant for multi-channel LDA systems. In contrast to the prior art, where a number of mostly large optics units are usually required for the multi-channel LDA, the proposed optical device for a number of LDA channels can be constructed in a compact manner. Likewise, the number of LDA channels can advantageously be increased without great effort, since an expensive and large optics unit is not required for each LDA channel. In this way, a measurement system for LDA with many LDA channels can be realized with an optical device.

In this way, an LDA system can advantageously be implemented over a large angular range. In an LDA system with a 25 mm exit aperture, for example, Strehl ratios greater than 0.8 are possible over an angular range of +/−10°, wherein the Strehl ratio represents the ratio of the observed maximum intensity of a point source in the image plane to the theoretical maximum intensity of a perfect diffraction limited optical device. A perfect imaging device would have a Strehl ratio of 1.0.

The at least one plane or curved surface in which the light passage surface of the at least one transceiver element is arranged or intersects the same can intersect the optical axis of the optical device obliquely or perpendicularly.

The distance, in particular the first and/or second distance, from the imaging surface depends on the specific application. With coherent laser Doppler anemometry LDA on individual scatterers, distances of a few tens of centimeters to a few meters are common. Wind Lidar systems cover distances from almost 100 m to several km.

The “Navigation Doppler Lidar” (NDL) is being studied at NASA for robotic landing on other celestial bodies, which means that distances of up to a few 10 km are common. In this case, prior art comprises the use of several differently aligned focusing and/or collimation optics, which can be achieved by the invention in a single optical system.

According to an advantageous configuration of the optical device, a plurality of transceiver elements can be provided, which are arranged on the at least two different surfaces along the optical axis, wherein the second distance is smaller than the first distance.

It is advantageously possible to arrange the transceiver elements on curved or planar surfaces. This allows an almost diffraction-limited imaging of the collimated beams to infinity. For example, an FMCW LIDAR system can be implemented over a large angular range. In an FMCW LIDAR system, for example, with an exit aperture of 25 mm, Strehl ratios greater than 0.9 are possible over an angular range of +/−10°.

This means that an FMCW LIDAR channel can be collimated centrally and a plurality of LDA channels can be refocused and tilted to one another with the same optical unit.

Such a combination for both LDA and FMCW LIDAR has the advantage that the optical device does not have to be switched between the two methods. This advantageously allows simultaneous measurements with LDA and FMCW LIDAR.

According to an advantageous configuration of the optical device, the at least one surface, in which the light passage surface of the at least one transceiver element is arranged, can be curved and bent away from the optical unit. A curvature of the image field of the optical device is curved towards the transceiver unit and away from the optical unit. Alternatively, the at least one surface can be planar. In particular, the at least one plane surface can be arranged perpendicular to the optical axis.

The transceiver elements can, for example, be arranged obliquely on a curved or plane surface, in particular perpendicular to the optical axis. An almost diffraction-limited reimaging of the transceiver elements can take place from a curved surface. If the transceiver elements are on a curved surface, then the images of the transceiver elements are also on a curved imaging surface. If the transceiver elements are on a plane surface, the images of the transceiver elements can be on a plane or curved imaging surface, depending on the quality of the optical unit.

According to an advantageous configuration of the optical device, the points of intersection of the light passage surfaces of the transceiver elements with the at least one curved surface can be arranged in one plane. In particular, the plane with the points of intersection can touch the curved surface at a vertex lying on the optical axis.

In a preferred embodiment, the transceiver elements may each lie on one of the intersection lines of a planar plane with the curved surfaces for the transceiver elements at both distances for reimaging and collimated light beams. In this way, transceiver elements for an LDA system can be arranged on a circle and a transceiver element for an FMCW LIDAR system can be arranged centrally on a point on the optical axis. Both imaging conditions can advantageously be combined in almost any way in a given field of view in order to obtain a monolithic LDA and/or LIDAR system. A system in which the transceiver elements for both methods are on one respective plane represents an exemplary embodiment.

Advantageously, the light beams emitted by the transceiver elements can form light cones the diameter of which tapers in an imaging region on a side of the optical unit that faces away from the transceiver unit. The at least two optical lenses can advantageously be used to refocus light in a conical imaging region with an imaging quality that is essentially diffraction-limited. The optical lenses are preferably designed as aspherical lenses.

According to an advantageous configuration of the optical device, the optical unit can be designed as a ring-shaped reimaging optic. In this way, a multi-channel LDA system with a compact structure of optical device and transceiver elements can advantageously be achieved. In addition, the number of LDA channels can advantageously be increased at low additional cost.

According to an advantageous configuration of the optical device, the optical unit can be designed for diffraction-limited imaging of the at least one transceiver element. This means that an FMCW LIDAR channel can be collimated centrally and a plurality of LDA channels can be tilted to one another in a refocusing way with the same optical unit.

Alternatively or additionally, the optical unit can be designed as a centrally collimating lens system. In particular, the optical unit can be designed for diffraction-limited imaging of the at least one transceiver element. This means that an FMCW LIDAR channel can be collimated centrally and a plurality of LDA channels can be tilted to one another in a refocusing way with the same optical unit.

According to an advantageous configuration of the optical device, the transceiver elements can be arranged on the at least one surface at a radial distance from the optical axis which can correspond to at least 30%, preferably at least 35%, particularly preferably at least 40%, very particularly preferably at least 45% of half the radius of an aperture of the emitted light beams at the second optical lens. In particular, the radial distance can correspond approximately to half the radius of the aperture of the emitted light beams at the second optical lens.

In particular, at least some of the transceiver elements can be arranged on the at least one surface in a circle with a radius to the optical axis which can correspond to at least 30%, preferably at least 35%, particularly preferably at least 40%, particularly preferably at least 45% of half the radius of an aperture of the emitted light beams at the second optical lens, in particular approximately half the radius of the aperture of the emitted light beams at the second optical lens.

For example, for a multi-channel LDA system, a plurality of fiber ends of optical fibers, which transmit the light from a laser and represent the actual transceiver element, can be imaged offset via a lens. The transceiver elements illuminate the first lens with cones of light that are essentially parallel to the optical axis. A slight inclination is tolerable in this case. It is advantageous if the beams do not illuminate the first lens centrally, but at a radial distance.

The offset transillumination of the first lens causes asymmetrical aberrations that are typically mirror-symmetrical to the surface defined by the optical axis and fiber outlet. Therefore, these asymmetric errors, such as astigmatism or coma, are rotated for each image.

According to an advantageous configuration of the optical device, the light cone respectively emitted by one of the transceiver elements can illuminate the at least one first optical lens on half of its cross section, in particular between the edge and the optical axis.

In order to correct an asymmetrical error caused by the oblique transillumination of the first lens, an aspherical lens can be used, which is initially only illuminated on one half by the light cones of the individual fibers. In this way, asymmetrical aberrations can again be imparted exactly along the surface defined by the optical axis and the fiber outlet. By choosing the aspherical parameters, these can now be selected in such a way that they compensate for the asymmetrical errors of the second lens.

According to an advantageous configuration of the optical device, a distance between the at least one second optical lens and the at least one first optical lens can be set so that the light cones of the transceiver elements coming from the first optical lens centrally pass through the second optical lens overlapping each other, in particular with a high fill factor of at least 50%, preferably at least 70%, particularly preferably at least 90%. In this case, the light cones of the transceiver elements can advantageously traverse the second lens essentially centrally and with a high fill factor. The asymmetrical errors of the second lens can thus be compensated for in an advantageous manner.

According to an advantageous configuration of the optical device, the at least one first optical lens can have aspherical parameters, with which asymmetrical aberrations of the at least one second optical lens are compensated for when the transceiver elements are imaged.

In order to correct an asymmetrical error caused by the oblique transillumination of the first lens, an aspherical lens can be used, which is initially only illuminated on one half by the light cones of the individual fibers.

In this way, asymmetrical aberrations can again be imparted exactly along the surface defined by the optical axis and the fiber outlet. By choosing the aspherical parameters, these can now be selected in such a way that they compensate for the asymmetrical errors of the second lens.

Alternatively or additionally, the at least one second optical lens can have aspherical parameters, with which rotationally symmetrical imaging errors occurring when the transceiver elements are imaged by the at least one first optical lens are compensated for when the transceiver elements are imaged by the at least one second optical lens.

The first lens of the optical unit can advantageously be transilluminated in an offset manner. Thus, due to the asphere of the first lens, asymmetrical lens errors can be imparted and the light beam is bent to the second lens. Asphere is understood to be the case of an optical lens with at least one refracting surface that deviates from a spherical shape or a planar shape.

The second lens is transilluminated obliquely and would normally have lens errors due to the obliquely incident light. However, these errors are anticipated by the first asphere so that they can be compensated at the end.

Rotationally symmetrical errors remain, which can be compensated for by using a second asphere as a second lens.

With the correction of the asymmetrical errors of the second optical lens due to the oblique illumination of the first optical lens by the light cones, only rotationally symmetrical imaging errors remain.

In order to remedy this, the second optical lens can also be designed as an aspherical optical lens. Thus, with the optical device according to the invention, both rotationally symmetrical and asymmetrical aberrations can be advantageously compensated for.

According to an advantageous configuration of the optical device, at least one transceiver element of the transceiver unit can be provided, the light passage surface of which intersects the optical axis and is arranged at the second distance from the first optical lens, wherein the light beam of the at least one transceiver element is formed to be collimated in the direction of the optical axis after passing through the optical unit.

The lens combination of the optical device according to the invention makes it possible, for example, to position a centrally placed optical fiber somewhat closer to the first optical lens and in doing so again generate an almost diffraction-limited collimated light beam. This means that an FMCW LIDAR channel can be collimated centrally and a plurality of LDA channels can be imaged while tilted to one another in a refocusing way with the same optical unit.

Such a combination for both LDA and FMCW LIDAR has the advantage that the optical device does not have to be switched between the two methods. This advantageously allows simultaneous measurements with LDA and FMCW LIDAR. A system in which the transceiver elements for both methods are on one respective plane represents a preferred exemplary embodiment.

According to an advantageous configuration of the optical device, the at least one transceiver element can be designed to carry out a frequency-modulated continuous-wave LIDAR method.

This means that an FMCW LIDAR channel can be collimated centrally and a plurality of LDA channels can be imaged tilted to one another in a refocusing way with the same optical unit.

Such a combination for both LDA and FMCW LIDAR has the advantage that the optical device does not have to be switched between the two methods. This advantageously allows simultaneous measurements with LDA and FMCW LIDAR.

According to an advantageous configuration of the optical device, the plane or curved surface in which the light passage surface of the at least one transceiver element is arranged can intersect the optical axis obliquely, in particular at an angle between 1° and 89°. However, the surface can advantageously also be arranged perpendicular to the optical axis and be rotationally symmetrical to the optical axis. This results in simple optical imaging conditions.

According to an advantageous configuration of the optical device, the transceiver elements can have beveled ends of optical fibers as light passage surfaces. For example, a normal to the light passage surface of an optical fiber can in each case have an angle of less than 10°, in particular of at most 8°, relative to a longitudinal axis of the respective optical fiber. The longitudinal axis of the optical fibers can advantageously be inclined a few degrees relative to the optical axis of the optical device in order to achieve the proposed illumination of the first optical lens. For example, the longitudinal axis can be inclined by less than 10°, in particular by at most 4°, relative to the optical axis.

The transceiver unit can advantageously be designed as an array of optical fibers. Instead of arranging the optical fibers separately as individual fibers in a fiber mount, it is also advantageously possible to use an array of optical fibers. The optical fibers are kept expediently and compact and can advantageously be aligned together in the optical device.

The optical device for near and distance imaging can advantageously have an optical unit which has at least one first optical lens and at least one second optical lens along the optical axis. The optical device can comprise a transceiver unit with at least two, in particular essentially punctiform, transceiver elements for emitting and receiving light beams through the optical unit. At least one light beam, in particular of a laser system, can be split into a reference beam and a measurement beam. The measurement beam can be emitted by at least one transceiver element via the optical unit and focused on an imaging plane.

Another light beam, in particular from the laser system, can also be split into a reference beam and a measurement beam, and the measurement beam can be sent from the at least one other transceiver element in a collimated way in parallel to the optical axis of the optical device in the direction of the imaging plane. The transceiver elements of the one light beam and of the further light beam can be arranged in such a way that the further light beam is emitted and received closer to the first lens than the one light beam. Advantageously, the transceiver element of the further light beam can be arranged essentially in the optical axis and the transceiver elements of the one light beam can be arranged on a circle around the optical axis.

Light from both light beams scattered in the imaging plane can be imaged by the optical unit back onto the respective transceiver elements, from where the light beams received there can be guided to optical detectors of the respective transceiver elements, superimposed with the respective reference beams and analyzed.

According to a further aspect of the invention, a system for laser Doppler anemometry is proposed, at least comprising an optical device for near and distance imaging as described above.

In particular, the system for laser Doppler anemometry comprises an optical device for near and distance imaging, comprising an optical unit with at least one first optical lens and at least one second optical lens, wherein the at least one first optical lens and at least one second optical lens are arranged along an optical axis.

The optical device also includes a transceiver unit with at least one, in particular an essentially punctiform, transceiver element for emitting and receiving light beams through the optical unit, wherein a light passage surface of the at least one transceiver element is arranged in or intersecting at least one plane or curved surface. A first distance between the at least one surface and the at least one first optical lens is set along the optical axis such that in normal operation conditions, the at least one transceiver element of the transceiver unit is imaged by the optical unit onto a distant imaging surface.

The optical device according to the invention consists of as few components as possible, namely an optical device with at least two aspherical optical lenses, which enable refocusing of light in a conical imaging region with an essentially diffraction-limited imaging quality. In this way, a plurality of LDA optical units can advantageously be combined in an optical system, as a result of which the number of LDA channels can be increased at low cost.

This is particularly relevant for multi-channel LDA systems. The proposed system can be built compactly for multiple LDA channels. Likewise, the number of LDA channels can advantageously be increased without great effort, since an expensive and large optics unit is not required for each LDA channel. In this way, a measurement system for LDA with many LDA channels can be implemented.

According to a further aspect of the invention, a system for LIDAR measurements is proposed, at least comprising an optical device for near and distance imaging as described above.

In particular, the system for LIDAR measurements comprises an optical device for near and distance imaging, comprising an optical unit with at least one first optical lens and at least one second optical lens, wherein the at least one first optical lens and the at least one second optical lens are arranged along an optical axis. The optical device also comprises a transceiver unit with at least one, in particular an essentially punctiform, transceiver element for emitting and receiving light beams through the optical unit, wherein a light passage surface of the at least one transceiver element is arranged in or intersecting at least one plane or curved surface.

Alternatively, a second distance between the at least one surface of the at least one transceiver element and the at least one first optical lens is set along the optical axis so that in normal operation, the light beam emitted by the at least one transceiver element is formed to be collimated at least after the second lens.

It is advantageously possible to arrange the transceiver elements on curved or plane surfaces. This allows an almost diffraction-limited imaging of the collimated beams to infinity. For example, a LIDAR system can be implemented over a large angular range. In a LIDAR system, for example, with an exit aperture of 25 mm, Strehl ratios greater than 0.9 are possible over an angular range of +/−10°.

The system according to the invention for LIDAR measurements is particularly advantageously suitable for frequency-modulated continuous-wave LIDAR measurements.

According to a further aspect of the invention, a system for combined laser Doppler anemometry and LIDAR measurements is proposed, at least comprising an optical device for near and distance imaging as described above.

In particular, the system for combined laser Doppler anemometry and LIDAR measurements comprises an optical device for near and distance imaging, comprising an optical unit with at least one first optical lens and at least one second optical lens, wherein the at least one first optical lens and the at least one second optical lens are arranged along an optical axis.

The optical device also includes a transceiver unit with at least one, in particular an essentially punctiform, transceiver element for emitting and receiving light beams through the optical unit, wherein a light passage surface of the at least one transceiver element is arranged in or intersecting at least one plane or curved surface. A first distance between the at least one surface and the at least one first optical lens is set along the optical axis such that in normal operation as intended, the at least one transceiver element of the transceiver unit is imaged by the optical unit onto a distant imaging surface.

Alternatively or additionally, a second distance between the at least one surface of the at least one transceiver element and the at least one first optical lens is set along the optical axis so that in normal operation as intended, the light beam emitted by the at least one transceiver element is formed to be collimated at least after the second lens.

The optical device according to the invention consists of as few components as possible, namely an optical device with at least two aspherical optical lenses, which enable refocusing of light in a conical imaging region with an essentially diffraction-limited imaging quality. In this way, a plurality of LDA optical units can advantageously be combined in an optical system, as a result of which the number of LDA channels can be increased at low cost.

The lens combination of the optical unit according to the invention makes it possible, for example, to position a centrally placed optical fiber slightly closer to the first optical lens and in doing so again generate an almost diffraction-limited collimated light beam.

This means that an LIDAR channel can be collimated centrally and a plurality of LDA channels can be imaged tilted to one another in a refocusing way with the same optical unit.

Such a combination for both LDA and LIDAR has the advantage that the optical device does not have to be switched between the two methods. This advantageously allows simultaneous measurements with LDA and LIDAR.

Advantageously, the system according to the invention for combined LDA and LIDAR measurements is particularly suitable for frequency-modulated continuous-wave LIDAR measurements.

### BRIEF DESCRIPTION OF THE DRAWINGS

Further advantages will be apparent from the description of the drawings. Exemplary embodiments of the invention are shown in the figures. The figures, the description, and the claims contain numerous features in combination. A person skilled in the art will expediently also consider the features individually and combine them into further meaningful combinations.

In the exemplary figures:

FIG. 1 shows an optical device for near and distance imaging according to an exemplary embodiment of the invention in a longitudinal section;

FIG. 2 shows the optical device according to FIG. 1 in an isometric view;

FIG. 3 shows the optical device according to FIG. 1 in an isometric view with an imaging region;

FIG. 4 shows the transceiver unit of the optical device according to FIG. 1 in a longitudinal section;

FIG. 5 shows a transceiver unit of the optical device according to a further exemplary embodiment in a longitudinal section;

FIG. 6 shows a transceiver unit of the optical device according to a further exemplary embodiment in a longitudinal section;

FIG. 7 shows a schematic representation of a system for laser Doppler anemometry according to an exemplary embodiment of the invention; and

FIG. 8 shows a schematic representation of a system for frequency modulated continuous wave LIDAR according to an exemplary embodiment of the invention.

### DETAILED DESCRIPTION

In the figures, identical or identically acting components are identified by the same reference signs. The figures only show examples and are not to be understood as restrictive.

Directional terminology used in the following with terms such as “left”, “right”, “above”, “below”, “in front of”, “behind”, “after”, and the like only serves for better comprehension of the figures and is in no way intended to restrict the generality. The components and elements shown, their design and use can vary according to the considerations of a person skilled in the art and can be adapted to the respective applications.

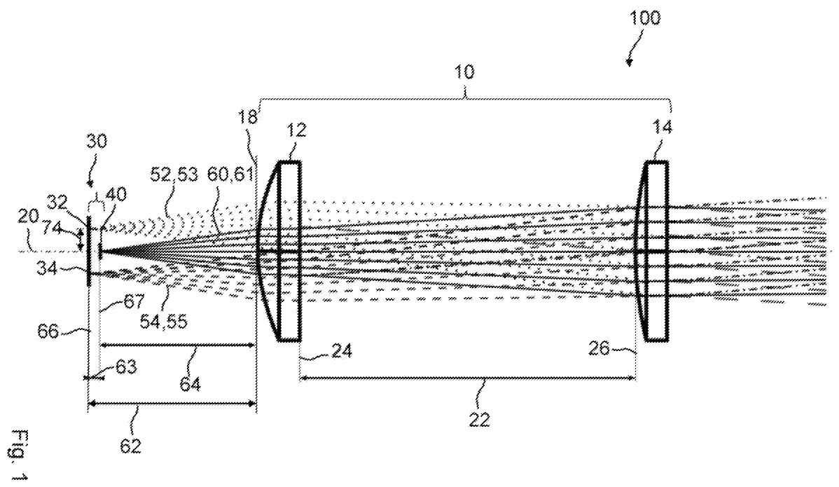

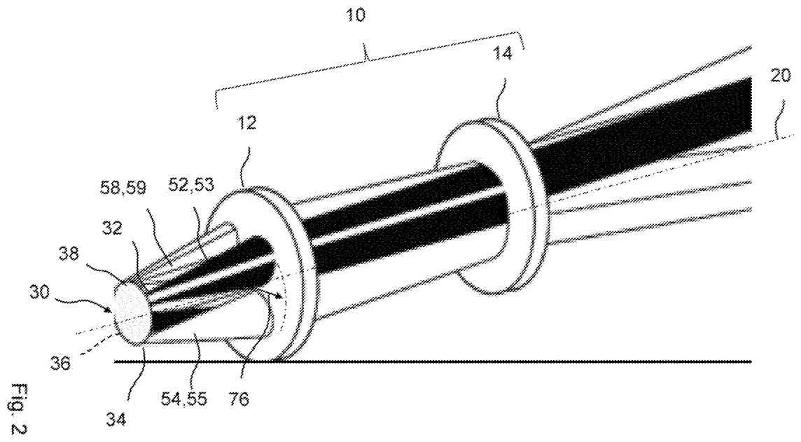

FIG. 1 shows an optical device 100 for near and distance imaging according to an exemplary embodiment of the invention in a longitudinal section, while FIG. 2 shows the optical device 100 in an isometric representation.

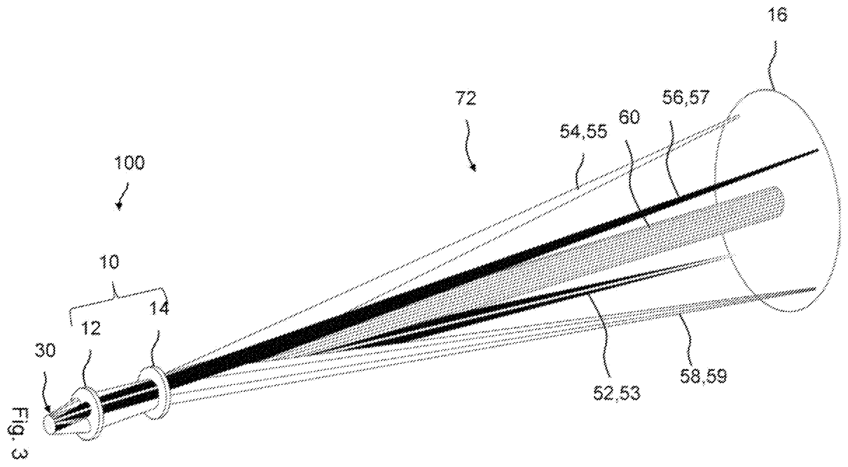

FIG. 3 shows the optical device 100 according to FIG. 1 in an isometric representation, with an imaging region 72;

The optical device 100 for near and distance imaging comprises an optical unit 10 with a first optical lens 12 and a second optical lens 14, wherein the first optical lens 12 and the second optical lens 14 are arranged along an optical axis 20. The two lenses 12, 14 are designed as aspherical lenses.

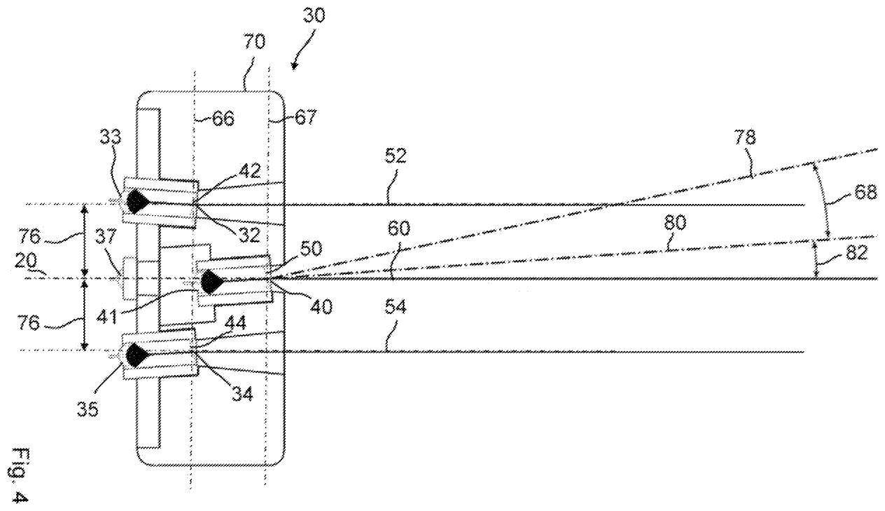

The optical device 100 further comprises a transceiver unit 30 with four essentially punctiform transceiver elements 32, 34, 36, 38 for emitting and receiving light beams 52, 54, 56, 58 through the optical unit 30. The light passage surfaces 42, 44, 46, 48, 50 of the transceiver elements 32, 34, 36, 38, 40, which can be seen in FIGS. 4 to 6, are each arranged in or intersecting a plane or curved surface 66, 67, which can obliquely intersect the optical axis 20, for example.

In the exemplary embodiment illustrated in FIGS. 1 to 4, the transceiver elements 32, 34, 36, 38, 40 are arranged on the surfaces 66, 67 perpendicular to the optical axis 20.

A first distance 62 between the one surface 66 and the first optical lens 12 is set along the optical axis 20 in such a way that, during intended normal operation, the transceiver elements 32, 34, 36, 38 of the transceiver unit 30 are imaged onto a distant imaging surface 16, shown in FIG. 3, by the optical unit 10. The surface 66 is assigned to the transceiver elements 32, 34, 36, 38.

Along the optical axis 20 a second distance 64, which differs from the first distance 62, between the one surface 67, which is assigned to the one transceiver element 40, and the first optical lens 12 is also set in such a way that in normal intended operation, the light beam 60 emitted by the one transceiver element 40 is formed to be collimated at least after the second lens 14

The distance 62 is defined between the surface 66 and a tangential plane 18 at the vertex of the first optical lens 12, while the distance 64 is defined between the surface 67 and the tangential plane 18 at the vertex of the first optical lens 12.

In the exemplary embodiment illustrated in FIG. 1, a plurality of transceiver elements 32, 34, 36, 38, 40 are provided, which are arranged on the at least two different surfaces 66, 67 along the optical axis 20, wherein the second distance 64 is smaller than the first distance 62. Conveniently, the transceiver element 40 is arranged on the optical axis 20, while the transceiver elements 32, 34, 36, 38 are arranged in a circle about the optical axis.

The transceiver elements 32, 34, 36, 38 can be obliquely arranged, for example, on a curved or plane surface 66, in particular perpendicular to the optical axis 20, as in the exemplary embodiment shown here. From a curved surface 66, an almost diffraction-limited reimaging of the transceiver elements 32, 34, 36, 38 can take place. If the transceiver elements 32, 34, 36, 38 are on a curved surface 66, the images of the transceiver elements 32, 34, 36, 38 are also on a curved imaging surface 16. If the transceiver elements are on a plane surface 66, the images of the transceiver elements 32, 34, 36, 38 can lie on a plane or curved imaging surface 16, depending on the quality of the optical unit.

The at least one surface 66, 67 can be curved and bent away from the optical unit 10. Alternatively, the at least one surface 66, 67 can be plane. In particular, the plane surface 66, 67 can be arranged perpendicular to the optical axis 20, as in FIG. 1.

Intersection points of the light passage surfaces 42, 44, 46, 48, 50 of the transceiver elements 32, 34, 36, 38, 40 with the at least one curved surface 66, 67 can be arranged in one plane. In particular, the plane with the points of intersection can touch the curved surface 66, 67 at a vertex lying on the optical axis 20.

For this purpose, the optical unit 10 is advantageously designed as a ring-shaped reimaging optic.

The optical unit 10 is designed for diffraction-limited imaging of the transceiver elements 32, 34, 36, 38, 40.

The optical unit 10 is further designed as a centrally collimating optic. The collimated light beam 60 can be seen in particular in FIG. 3 after passing through the optical unit 10.

The transceiver elements 32, 34, 36, 38 are arranged on the surface 66 at a radial distance 74 from the optical axis 20, which in this example corresponds approximately to half a radius of an aperture of the emitted light beams 52, 54, 56, 58, 60 on the second optical lens 14. In particular, at least some of the transceiver elements 32, 34, 36, 38 can be arranged on the surface 66 in a circle with a radius 76 (shown in FIG. 2) relative to the optical axis 20, which radius approximately corresponds to half a radius of an aperture of the emitted light beams 52, 54, 56, 58, 60 on the second optical lens 14.

The light beams 52, 54, 56, 58 emitted by the transceiver elements 32, 34, 36, 38 form light cones 53, 55, 57, 59, the diameter of which tapers in an imaging region 72 on a side of the optical unit 10 facing away from the transceiver unit 30. The imaging of the transceiver elements 32, 34, 36, 38 by means of the optical unit 10 in the imaging region 72 onto the remote imaging surface 16 is shown in FIG. 3.

The respective emitted light cone 53, 55, 57, 59 of one of the transceiver elements 32, 34, 36, 38 illuminates the first optical lens 12 on half of its cross section, in particular between the edge and the optical axis 20.

This can be seen in the longitudinal section in FIG. 1 in the form of the light cones 53, 55 represented by dotted and dashed lines.

The second optical lens 14 is arranged at a distance 22 from the first optical lens 12, which is set so that the light cones 53, 55, 57, 59, 61 of the transceiver elements 32, 34, 36, 38, 40 starting from the first optical lens 12, centrally traverse the second optical lens 14 in an overlapping manner, in particular with a high fill factor of 50%, preferably at least 70%, particularly preferably at least 90%. The distance 22 is defined between the back surface 24 of the first optical lens 12 and a tangential plane 26 at the apex of the second optical lens 14.

The first optical lens 12 can advantageously have aspherical parameters, with which asymmetrical aberrations of the at least one second optical lens 14 are compensated for when the transceiver elements 32, 34, 36, 38 are imaged.

The second optical lens 14 can in turn have aspherical parameters, with which rotationally symmetrical aberrations occurring when imaging the transceiver elements 32, 34, 36, 38 through the first optical lens 12 are compensated for when imaging the transceiver elements 32, 34, 36, 38 by the second optical lens 14.

In addition to the transceiver elements 32, 34, 36, 38, which are arranged on the surface 66, a further transceiver element 40 is provided in the transceiver unit 30, the light passage surface 50 of which intersects the optical axis 20 and is arranged at the second distance 64 to the first optical lens 12.

The light beam 60 of the at least one transceiver element 40 is formed to be collimated in the direction of the optical axis 20 after passing through the optical unit 10.

The further transceiver element 40 is arranged at a distance 64 from the first optical lens 12, which distance is smaller by a difference 63 than the distance 62 of the other transceiver elements 32, 34, 36, 38 from the first optical lens 12.

The further transceiver element 40 is arranged on the optical axis 20 and emits a light beam 60 with a light cone 61 in the direction of the optical axis 20.

The further transceiver element 40 can advantageously be designed to carry out a frequency-modulated continuous-wave LIDAR method.

FIG. 4 shows the transceiver unit 30 of the optical device 100 according to FIG. 1 in a longitudinal section.

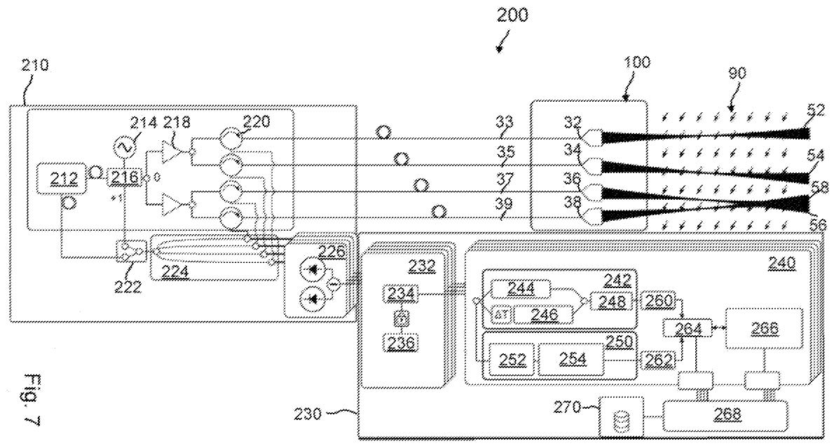

In the transceiver unit 30 five transceiver elements 32, 34, 36, 38, 40 are arranged, of which only four of the five optical fibers 33, 35, 37, 39, 41 can be seen in FIG. 4, which fibers are arranged in a fiber mount 70. The optical fibers 33, 35, 37, 39, 41 have beveled ends which represent light passage surfaces 42, 44, 46, 48, 50 of the transceiver elements 32, 34, 36, 38, 40. The light passage surfaces of the optical fibers 37, 39 are clipped in the figure due to the sectional view (optical fiber 37 is hinted to in FIG. 7). The transceiver elements 32, 34, 36, 38, 40 in the exemplary embodiment shown emit light cones 53, 55, 57, 59, 61 parallel to the optical axis 20.

The transceiver elements 32, 34, 36, 38 of the transceiver unit 30 lie on a surface 66, while the transceiver element 40 is arranged on the second surface 67.

The beveled ends of the optical fibers 33, 35, 37, 39, 41 are designed in such a way that a normal 78 to the light passage surface 42, 44, 46, 48, 50 of an optical fiber 33, 35, 37, 39, 41 has an angle 68 of less than 10°, in particular at most 8°, relative to a longitudinal axis 80 of the respective optical fiber 33, 35, 37, 39, 41.

The angle 68 is shown as an example in the case of the one optical fiber 41. The longitudinal axes 78 of the optical fibers 33, 35, 37, 39, 41 are tilted at an angle 82 with respect to the optical axis 20. The angle 82 is less than 10° and in particular at most 4°.

The transceiver elements 32, 34, 36, 38 arranged on the surface 66 are arranged on a circle at a radial distance 76 around the optical axis 20.

Optionally, the transceiver unit 30 can be designed as an array of optical fibers 33, 35, 37, 39, 41 instead of as a fiber mount 70 with individual optical fibers 33, 35, 37, 39, 41.

In the exemplary embodiment of an optical device 100 according to the invention illustrated in FIGS. 1 to 4, intersection points of the light passage surfaces 42, 44, 46, 48, 50 of the transceiver elements 32, 34, 36, 38, 40 are arranged with the at least one curved surface 66, 67 in a plane. In particular, the intersection points of the plane touch the curved surface 67 at a vertex lying on the optical axis 20.

In this way, in the exemplary embodiment shown, the transceiver elements 32, 34, 36, 38 for LDA are arranged in a circle and the transceiver element 40 for FMCW LIDAR is arranged centrally at a point on the optical axis 20.

Advantageously, both imaging conditions can be combined in almost any way in a given field of view in order to create a monolithic system for LDA and FMCW LIDAR.

The embodiment of an optical device 100 according to the invention shown in FIGS. 1 to 4 thus represents a special case of a general optical device 100 in which the transceiver elements 32, 34, 36, 38, 40 are arranged on two curved surfaces.

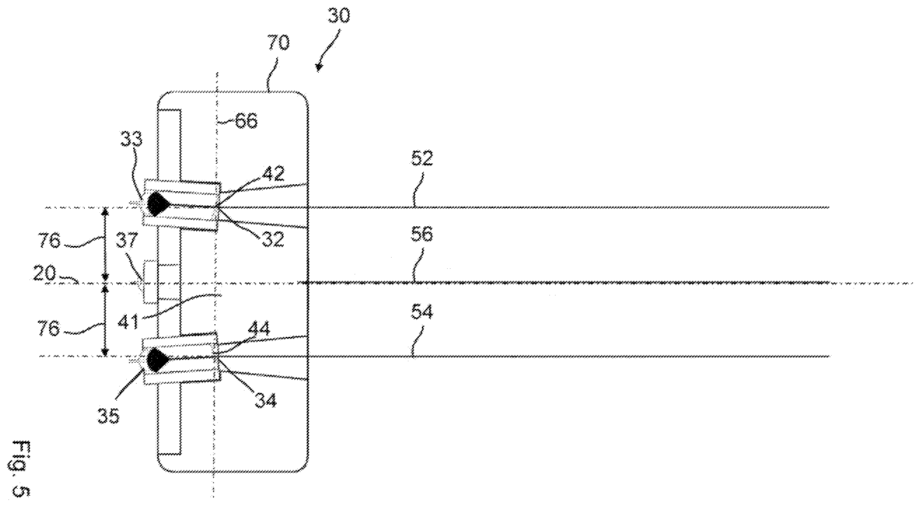

FIG. 5 shows a transceiver unit 30 of the optical device 100 according to a further exemplary embodiment in a longitudinal section.

The optical device 100 can be provided in particular for a system 200 for laser Doppler anemometry. In this case, transceiver elements 32, 34, 36, 38 are arranged on a surface 66.

A first distance 62 between the surface 66 and the first optical lens 12 can be set along the optical axis 20, as defined in FIG. 1, in such a way that, during intended normal operation, the transceiver elements 32, 34, 36, 38 of the transceiver unit 30 are imaged onto the distant imaging surface 16 by the optical unit 10.

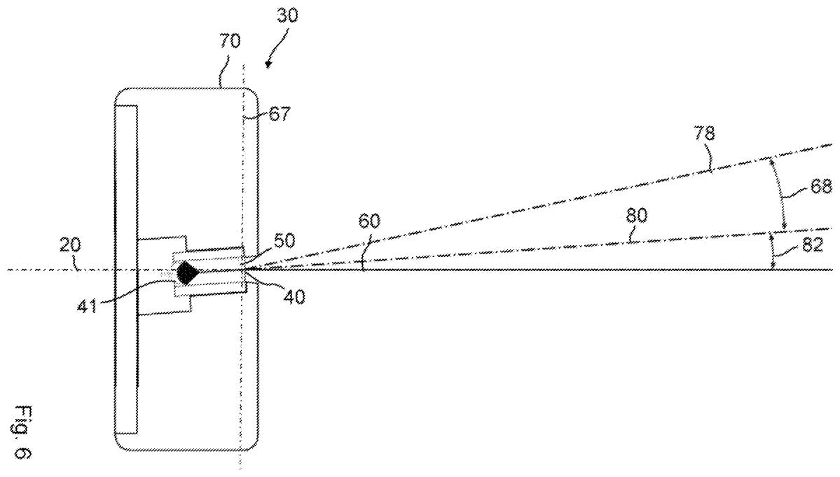

FIG. 6 shows a transceiver unit 30 of the optical device 100 according to a further exemplary embodiment in a longitudinal section.

In particular, the optical device 100 can be provided for a system 300 for frequency modulated continuous wave LIDAR. In particular, a transceiver element 40 is arranged on a surface 67.

A second distance 64 between the surface 67 of the transceiver element 40 and the first optical lens 12 can be set along the optical axis 20 such that, in normal intended operation, the light beam 60 emitted by the transceiver element 40 is formed to be collimated at least after the second lens 14.

FIG. 7 shows a schematic representation of a system 200 for laser Doppler anemometry according to an exemplary embodiment of the invention. The system 200 comprises an optical device 100 according to the invention, as described above.

In order to generate light beams, the system 200 has a laser system 210 which comprises a laser 212, such as an erbium-doped semiconductor laser. An oscillator 214 generates a signal which is modulated onto the laser beam in a modulator 216, which laser beam is then fed into four circulators 220 via optical amplifiers 218.

The light beams of the laser 212 are guided into the optical device 100 via optical fibers 33, 35, 37, 39.

The optical fibers 33, 35, 37, 39 are used to form transceiver elements 32, 34, 36, 38 which transmit light beams 52, 54, 56, 58 into a flow field 90.

Scattered light beams are received by the optical device 100 via the transceiver elements 32, 34, 36, 38 and are fed again to the circulators 220 via the optical fibers 33, 35, 37, 39. The decoupled, scattered light beams are fed into an interferometer 224 via the circulators 220 and made to interfere with reference light beams, which are fed in via an optical switch 222 from the laser 212 and from the modulator 216. These interfered light beams are detected in a detector 226 by means of photodiodes.

The detected signals are further processed in an analysis unit 230.

The signals from the detector 226 are first converted digitally in an analog-to-digital converter (ADC) unit 232 using an ADC 234, which is controlled via a phase-locked loop 236, and processed further in a data processing system 240, for example.

This data processing system 240 has an event detection unit 242 with a Fast Fourier Transform (FFT) unit 244, 246 and a trigger unit 248. The data processing unit 240 also comprises an averaging unit 250 with a further FFT unit 252 and a block memory 254.

Signals from the event detection unit 242 and from the averaging unit 250 are stored in a fast semiconductor memory 264 via direct memory access units 260, 262.

The data from the semiconductor memory 264 are further processed via a Linux processor 266 in a central measuring and control system 268 with a connected memory 270.

If the transceiver elements 32, 34, 36, 38 are arranged on a curved surface, an almost diffraction-limited reimaging of the fiber ends can take place. In this way, an LDA system can advantageously be implemented over a large angular range. In a LIDAR system, which, for example, has an exit aperture of 25 mm, Strehl ratios greater than 0.8 are possible over an angular range of +/−10°.

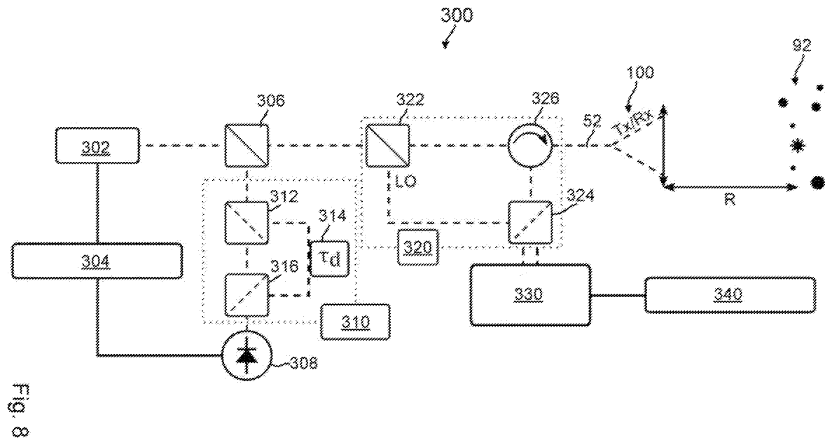

FIG. 8. shows a schematic representation of a system 300 for frequency modulated continuous wave LIDAR according to an exemplary embodiment of the invention. The system 300 comprises an optical device 100 according to the invention, as described above. Dashed connecting lines represent optical signals, solid connecting lines represent electrical signals.

The system 300 comprises a laser 302, which generates a laser beam, the main beam of which is guided into a so-called ranging interferometer 320 via an optical beamsplitter 306, which can be embodied, for example, as a 99/1 beamsplitter.

A reference beam is guided into a further interferometer 310, which can be embodied as a so-called Mach-Zehnder interferometer, for example, and which comprises two further beamsplitters 312, 316, which can be embodied as 50/50 beamsplitters, for example, and a delay element 314.

An electrical signal from the laser 302 generates a further light signal via a linearization unit 304 and a photodiode 308, which light signal is also fed into the interferometer 310.

The laser beam for the measurement task is guided in the ranging interferometer via the 99/1 beamsplitter 322 to the circulator 326, from where the laser beam 52 is emitted via the optical device 100. A reference beam from beamsplitter 322 is guided into another beamsplitter 324.

The emitted light beam can be scattered by an aerosol cloud 92 and/or solid objects lying behind the same.

Scattered light beams received in the optical device 100 are also guided via the circulator 326 into the beamsplitter 324 and are made there to interfere with the reference beam. The signals are then detected in a detector 330.

Detected signals are further processed in a data analysis unit 340.

In an alternative exemplary embodiment, not shown here, it is possible to arrange the optical fibers on a curved surface. This allows an almost diffraction-limited imaging of the collimated beams to infinity. For example, an FMCW LIDAR system can be implemented over a large angular range. In an FMCW LIDAR system, for example, with an exit aperture of 25 mm, Strehl ratios greater than 0.9 are possible over an angular range of +/−10°.

### LIST OF REFERENCE NUMERALS

10 optical unit
12 first optical lens
14 second optical lens
16 imaging surface
18 tangential plane
20 optical axis
22 distance
24 back surface
26 tangential plane
30 transceiver unit
32 transceiver element
33 optical fiber
34 transceiver element
35 optical fiber
36 transceiver element
37 optical fiber
38 transceiver element
39 optical fiber
40 transceiver element
41 optical fiber
42 light passage surface
44 light passage surface
46 light passage surface
48 light passage surface
50 light passage surface
52 light beam
53 light cone
54 light beam
55 light cone
56 light beam
57 light cone
58 light beam
59 light cone
60 light beam
61 light cone
62 first distance
63 distance difference
64 second distance
66 surface
67 surface
68 angle
70 fiber mount
72 imaging region
74 distance
76 radius
78 normal to the light passage surface
80 longitudinal axis
82 angle
90 flow field
92 aerosol cloud
100 optical device
200 system for LDA
210 laser system
212 laser
214 oscillator
216 modulator
218 optical amplifier
220 circulator
222 switch
224 interferometer
226 photodiodes
230 analysis unit
232 ADC unit
234 ADC
236 phase locked loop
240 data processing system
242 event detection unit
244 FFT unit
246 FFT unit
248 trigger unit
250 averaging unit
252 FFT unit
254 block memory
260 direct memory access unit
262 direct memory access unit
264 semiconductor memory
266 Linux processor
268 central measurement and control system
270 memory
300 system for LIDAR
302 laser
304 linearization unit
306 beamsplitter
308 photodiode
310 interferometer
312 beamsplitter
314 delay element
316 beamsplitter
320 interferometer
322 beamsplitter
324 beamsplitter
326 circulator
330 detector
340 data analysis unit
400 system for LDA LIDAR

1. An optical device for near and distance imaging, comprising
an optical unit with at least one first optical lens and at least one second optical lens, wherein the at least one first optical lens and the at least one second optical lens are arranged along an optical axis,
a transceiver unit with at least one, in particular essentially punctiform, transceiver element for emitting and receiving light beams by the optical unit, wherein a light passage surface of the at least one transceiver element is arranged in or intersects at least one plane or curved surface,
wherein a first distance between the at least one surface and the at least one first optical lens is provided along the optical axis and set in such a way that, during intended normal operation, the transceiver element of the transceiver unit is imaged onto a distant imaging surface by the optical unit and/or
wherein a second distance different from the first distance is set along the optical axis between the at least one surface of the at least one transceiver element and the at least one first optical lens in such a way that, during intended normal operation, the light beam emitted by the at least one transceiver element is formed to be collimated at least after the second lens.

2. The optical device according to claim 1, wherein multiple transceiver elements are provided, which are arranged on the at least two different surfaces along the optical axis, wherein the second distance is smaller than the first distance.

3. The optical device according to claim 1, wherein the at least one surface in which the light passage surface of the at least one transceiver element is arranged, is curved and bent away from the optical unit, or the at least one surface is plane.

4. The optical device according to claim 3, wherein intersection points of the light passage surfaces of the transceiver elements with the at least one curved surface are arranged in a plane.

5. The optical device according to claim 1, wherein the optical unit is in the form of a ring-shaped reimaging optics.

6. The optical device according to claim 1, wherein the optical unit is designed for diffraction-limited imaging of the at least one transceiver element, and/or wherein the optical unit is designed as a centrally collimating optics.

7. The optical device according to claim 1, wherein the transceiver elements are arranged on the at least one surface at a radial distance from the optical axis, which distance corresponds to at least 30% of a radius of an aperture of the emitted light beams at the second optical lens.

8. The optical device according to claim 1, wherein the respectively emitted light cone of one of the transceiver elements illuminates the at least one first optical lens on half of its cross section, in particular between the edge and the optical axis.

9. The optical device according to claim 1, wherein a distance between the at least one second optical lens and the at least one first optical lens is set so that the light cones of the transceiver elements, starting from the first optical lens, centrally traverse the second optical lens so that they overlap each other.

10. The optical device according to claim 1, in which the at least one first optical lens has aspherical parameters with which asymmetrical aberrations of the at least one second optical lens are compensated when the transceiver elements are imaged,
and/or
wherein the at least one second optical lens has aspherical parameters with which, upon imaging the transceiver elements by the at least one first optical lens, occurring rotationally symmetrical aberrations are compensated for, upon imaging the transceiver elements by the at least one second optical lens

11. The optical device according to claim 1, wherein at least one transceiver element of the transceiver unit is provided, the light passage surface and is arranged at the second distance from the first optical lens, wherein the light beam of the at least one transceiver element is formed to be collimated in the direction of the optical axis after passing through the optical unit.

12. The optical device according to claim 11, wherein the at least one transceiver element is provided for carrying out a frequency-modulated continuous-wave LIDAR method.

13. The optical device according to claim 1, wherein the plane or curved surface in which the light passage surface of the at least one transceiver element is arranged, intersects the optical axis obliquely.

14. The optical device according to claim 1, wherein the transceiver elements, as light passage surfaces, have beveled ends of optical fibers.

15. A system for laser Doppler anemometry, comprising an optical device according to claim 1.

16. A system for LIDAR measurements, at least comprising an optical device according to claim 1.

17. A system for combined laser Doppler anemometry and LIDAR measurements comprising an optical device according to claim 1.
